(19) United States
(12) Patent Application Publication
(10) Pub. No.: US 2006/0076543 A1
(43) Pub. Date: Apr. 13, 2006

(54) Compact modular lifting and holding apparatus

(76) Inventor: Barton K. Williamson, Los Gatos, CA (US)

Correspondence Address: Barton K. Williamson;J. Lisa Goldseger, 277 Hershner Court, P. O. Box 320396, Los Gatos, CA, 95032, US

(21) Appl. No.: 10/711,854

(22) Filed: Oct. 9, 2004

(51) Int. Cl. B66D 1/36

(52) U.S. Cl. 254/325

(57) ABSTRACT

A compact, modular, portable vehicle lifting and holding apparatus comprising either an individual lifting tower assembled from independent components, or one or more pairs of independent lifting tower assemblies interconnected by torsionally stiff support crossmembers, thereby forming a complete apparatus. Each lifting tower assembly is provided with redundant lifting carriage locking features, lifting means comprising a cable pulling device of conventional type, and further provided with ground traversing means whereby said complete apparatus is capable of ambulatory motion while supporting a load. Said apparatus includes means to engage and elevate a vehicle body independent of its frame, or elevate an entire vehicle or part thereof in a horizontal position relative to the level surface supporting said apparatus, thereby facilitating restoration, repair, and customization processes. Said complete apparatus has dimensions allowing operation within the confines of a conventional one-car residential garage, and disassembles completely for compact storage or transport.

### REFERENCES CITED

| | | | |
|---|---|---|---|
| U.S. Pat. No. 3,999,739 | Vick, et al. | May 19, 1975 | 254/409 |
| U.S. Pat. No. 4,235,420 | Ross, et al. | Nov. 20, 1978 | 254/218 |
| U.S. Pat. No. 4,008,881 | Ross, et al. | Mar. 17, 1975 | 254/369 |

### FIELD OF SEARCH

269/9,17,900,901,909

187/203,210,219,240,250,266,401,404,406,411

254/45,47,89R,389,390,397,399,401,402

212/175,176,180

248/351,352

211/175,209

414/222,223,678

### BACKGROUND OF THE INVENTION

The present invention relates to the art of vehicle lifting apparatus and, more particularly, the present invention relates to a method and an apparatus for lifting and holding automotive vehicles and vehicle bodies for the repair and restoration thereof.

In the fields of automotive repair, restoration, and customization/modification the most commonly found automotive lifting systems capable of elevating the entire vehicle are the single-post, twin-post, and four-post varieties. Generally, vehicle-lifting systems of these types are extremely bulky, require considerable space to operate, and restrict access to various areas of the vehicle surface or undercarriage. Vehicle lifting systems that support the vehicle on a platform provide limited access to the vehicle undercarriage, while systems employing wheel lifts or that support the vehicle on arms positioned underneath the vehicle frame may restrict access to the vehicle interior, doors, and side panels.

Approximately half of automotive repair shops use a twin-post lift, the vast majority of which employ hydraulic systems powered by electrical pumps as lift means. In addition to the previously detailed disadvantages of twin-post lifts, hydraulic lifts present further disadvantages relating to their electrical power requirements and the hydraulic fluid itself. Typically, these lifts require a 220-volt electrical outlet, as do air compressors, welders, plasma cutters, and other shop tools and equipment. Due to the limited number of these outlets usually found in smaller shops, wiring of additional 220-volt outlets, and the associated costs, may be necessary to provide a number sufficient to optimize use of the equipment and tools. Routine service and maintenance of hydraulic lifts includes the removal and disposal of used hydraulic fluid, known to be environmentally hazardous. Hydraulic fluid, while for the most part comprising an oil-based hydrocarbon, includes certain caustic and heavy metal additives including iron, lead, copper, nickel, tin, aluminum, cadmium, and phosphorus. As a result, removal and disposal of the used fluid requires special procedures and the involvement of governmental hazardous materials oversight agencies and other organizations.

Many of the tasks and processes involved in automotive restoration and customization or modification cannot be performed until the vehicle body has been removed from the frame. Use of a twin-post lift to accomplish this task involves balancing the vehicle body on the bottom edge of the pinch welded flanges that mate the floor to the rocker panels, a surface usually less than one quarter of an inch wide, these surfaces being supported by the lift arms. The extremely tight clearances between the vehicle body and frame make this task even more difficult. A condition where the body is not correctly balanced on the lift arms can be dangerous because the body may slip or fall off the lift, causing damage to the vehicle and injury to any persons who may be near or under the lift. As a result of these considerations the common practice is to promptly remove the vehicle body from the lift, once separated from the frame, and place it on some type of mobile work holder. This allows it to be moved around the shop while various processes, such as metalwork, sanding, welding, etc., are performed. While conventional twin-post lifts do not efficiently or effectively lend themselves to the process of vehicle body removal, use of conventional single-post or four-post lifting systems is not possible. Hence, the need exists for a vehicle lift that facilitates this process.

Another disadvantage of these conventional automotive lifts is the permanence of their installation. Most need to be professionally installed in a permanent location and generally require between one and two bays of shop floor space whether in use or not, while most collapsible types require as much as half of a bay when not in use, a standard shop bay having dimensions of approximately 15 feet times 30 feet. A surprisingly large percentage of commercial businesses providing automotive repair, restoration, or customization services operate from facilities having no more than four bays of floor space. Consequently, maximizing the productivity of such limited workspace is a critical factor in the ability of such businesses to achieve financial success. Regardless of issues concerning equipment workspace usage, most shops require a vehicle lift as well as many other pieces of bulky equipment including mobile work holders, which are a necessity when vehicles or parts thereof must be moved to different locations in the shop in order to complete various processes. A compact vehicle lift incorporating the functionality of a mobile work holder is therefore desirable.

Additionally, the minimum ceiling height required to accommodate the majority of automotive lifts is greater than the ceiling height used as the industry standard in construction of residential garages, thus prohibiting the use of such lifts in most non-commercial buildings.

While conventional automotive lifts may be suitable for their intended use, none can be operated within the confines of a residential garage of standard dimension while providing a sturdy and stable lifting system capable of elevating the entire vehicle, facilitating vehicle body removal, functioning as a mobile work holder when loaded, and that can be stored in a minimal amount of space when not in use.

Circumstances necessitating a vehicle lifting system having these characteristics and free from the aforementioned disadvantages and restrictions of conventional lifts required that an embodiment of the present invention be reduced to practice in the year 2002.

The apparatus according to the invention, summarized herewithin, fulfills a long felt need for a compact vehicle lifting system that provides for quick, efficient vehicle body removal as well as stable whole vehicle lifting, that adjusts to differing vehicle dimensions, functions as a mobile work holder, is easily transportable, and can be stored compactly.

### BRIEF SUMMARY OF THE INVENTION

The primary object of the present invention is to provide a compact vehicle lifting apparatus in which individual components are easily brought into cooperation to complete an operative apparatus and removed from cooperation for storage or transport, whereby use of the lifting apparatus is possible in a greatly increased range of circumstances.

Another object of the present invention is to provide a lifting apparatus free from the previously discussed disadvantages and limitations of conventional vehicle lifts.

An additional object of the present invention is to provide a vehicle lifting system comprised of easily manufacturable lightweight components whereby shipping is greatly simplified so as to reduce shipping and handling expense.

One preferred embodiment of the present invention comprises one pair of lifting tower assemblies, each lifting tower assembly having a base, upright support member, at least one diagonal support member, lifting carriage, load supporting assembly, pulley component, lifting means, ground traversing means, and at least one horizontally disposed longitudinal support crossmember. Said embodiment further comprises at least 2 torsionally stiff structural support crossmembers interconnecting said lifting tower assemblies which form said pair thereby forming an apparatus of generally rectangular structure.

Each lifting tower assembly is provided with ground traversing means, having a base component being movably supported on a plurality of wheels for ambulatory motion over a horizontal surface. Extending in a generally vertical direction from said base is a torsionally stiff upright support member. A lifting carriage is vertically slidable along the longitudinal axis of said upright support member, said lifting carriage being provided with a mounting site for attachment or connection of a conventional cable-engaging pulley device of an appropriate sort thereto One type of such conventional cable-engaging pulley device is commonly referred to as a snatch-block, an example of which is manufactured under U.S. Pat. No. 3,999,739, however an other appropriate type of cable-engaging pulley device may be employed in lie thereof.

Lift is provided to the lifting carriage assembly by a lifting means in cooperation with a pulley component located adjacent the uppermost end of the upright support member and a cable having sufficient strength and appropriate material composition. Said pulley component includes a cable engaging pulley device of appropriate conventional type connected thereto and is further provided with a cable locking means such that a cable passing through the locking means can be secured in a substantially immovable position relative to said pulley component thereby preventing movement in either direction. A lifting means is detachably connected or attached to one tail of said cable, the opposite tail passing through the locking device and extending around the lifting carriage pulley and extending over the pulley component pulley, is detachably connected or attached to same said lifting means in such manner that said lifting means interconnects both tails of said cable with said base. This configuration greatly increases the lifting capacity provided to the lifting carriage assembly by the cooperation of the lifting means and the cable, however an alternate embodiment of the present invention including other manner of cable configuration to provide interconnection between the lifting means, the pulley component, the lifting carriage assembly, and the base is possible.

In one embodiment of the present invention lifting means comprises a cable-pulling device of the ratcheting type known as a power pull, commonly referred to as a come-along, an example of which is manufactured by American Power Pull under U.S. Pat. Nos. 4,235,420 and 4,008,881. Said embodiment of the apparatus according to the invention provides the advantage that use of the vehicle lifting apparatus does not require an electrical power source, thereby eliminating any restrictions or expenses resulting from access to 220 volt or 110 volt outlets or lack thereof. It is to be understood that said power pull is representative of but one type of cable-pulling device and as the lifting means is detachably connected to the other lifting system components an alternate type of cable-pulling device, such as the type commonly known as an electric winch for example, can be utilized in lieu thereof without departing from the scope of the invention.

At least one vertically disposed diagonal support member having an upper end and a lower end interconnects the upright support member of each lifting tower assembly with the longitudinal crossmember attached thereto. An upper circumferential collar surrounding a segment of said upright support member and a lower circumferential collar surrounding a segment of said longitudinal crossmember connect the upper end and the lower end of the diagonal support member to the upright support member and the longitudinal crossmember respectively, the upper collar being positionable along the longitudinal axis of said upright support member and the lower collar being positionable along the length of said longitudinal crossmember. Said diagonal support member greatly increases the stability of the lifting system thereby minimizing the possibility of said upright support member tilting, twisting, or rotating relative to said longitudinal crossmember. Said upper circumferential collar is secured to the upright support member in a location upwards of the lifting carriage and has dimension in proportion to the lifting carriage whereby said upper collar limits movement of the lifting carriage towards the uppermost end of the upright support member thereby defining the uppermost position of the lifting carriage. Thus, said upper collar functions as a safety means and additionally, being positionable along the length of the upright support member, allows the operator to set the raised or uppermost position of the lifting carriage to the desired elevation by positioning and securing said upper collar in an appropriate location on the upright support member.

The apparatus according to the invention includes a load supporting assembly having sufficient strength and appropriate material composition and provided with means of attachment to the lifting carriage, and which in one embodiment comprises a main body, adjustable mounting brackets, and body attachment arms provided with a projecting portion shaped to fit within the channel existing adjacent the body mount locations of a full-frame automobile. The projecting portion is further provided with a connection means such that said projecting portion can be secured to the underside of the vehicle body in a manner whereby a body being lifted is supported from underneath by said projecting portion of the body attachment arms. Once said body attachment arms have been attached to the vehicle body the lifting tower assembly is moved into a position whereby the mounting brackets of the load supporting assembly are attachable to the body attachment arms. Consequently, the lifting apparatus automatically adjusts to fit vehicles of differing dimensions.

Said load supporting assembly in an alternate embodiment includes vehicle supporting arms having an upper surface forming a generally horizontal surface of sufficient size and strength whereby the vehicle being lifted is supported on the flat upper surfaces of the vehicle supporting arms which are placed in appropriately reinforced and stable points on the vehicle's undercarriage. The lifting tower assembly is assembled in a desired location adjacent the vehicle and moved into a position such that elevating the lifting carriage assembly results in contact between the upper flat surfaces of said vehicle supporting arm and an appropriate point on the vehicle undercarriage. Thus, the apparatus according to the invention provides the capability to lift a vehicle body off its frame or lift an entire vehicle by employing the appropriate load supporting assembly.

Additional alternate embodiments of said load supporting assembly provided with means to appropriately engage and support loads other than those specifically herein referenced are also possible.

The apparatus according to the invention includes at least two horizontally disposed torsionally stiff structural support crossmembers, each having sufficient strength and appropriate material composition, interconnecting the lifting tower assemblies which form a pair, thereby forming a stable structure. Said crossmembers interconnect the lifting tower assemblies in a manner such that a lower transverse crossmember is detachably attached to the base component of each of said lifting tower assemblies and an upper transverse crossmember is detachably attached to the lifting carriage assembly of each of said lifting tower assemblies.

When an embodiment of the apparatus according to the invention is used to lift a vehicle body off its frame, load attachment arms of an appropriate type are secured to the vehicle body and to the assembled lifting tower assemblies, then the lower transverse crossmember is attached. After disconnection from the frame, the vehicle body is elevated separately and the frame is then removed from underneath the elevated body. The capability of the apparatus to elevate a load in a stable and secure manner before attachment of the upper transverse crossmember allows the vehicle body to be lifted off its frame without obstruction. Said upper transverse crossmember is then attached and the lower transverse crossmember is removed from the lifting system, thereby allowing the frame, suspension, and etceteras to be removed from beneath the lifting system, there being no lower crossmember interfering with access. Said lower transverse crossmember is again attached, resulting in a single sturdy and stable structure having a vehicle body supported thereby.

Alternately, assembly of the complete apparatus including attachment of the previously herein defined vehicle supporting embodiment of said load supporting assembly provides the apparatus the ability to lift an entire vehicle or other suitable load. Additional alternate embodiments of said load supporting assembly are possible, whereby the apparatus according to the invention is able to engage and support a wide variety of loads having varying dimensions and differing requirements for appropriate engagement, support, and securing.

The apparatus includes ground-traversing means and, once all crossmembers are attached and secured, can be moved while supporting a load whereby the vehicle or part thereof can be conveniently relocated when necessary without removal from the lifting apparatus. Said apparatus supports loads from below in a manner providing unrestricted access to the upper surfaces and interior of the supported vehicle and greatly increased access to the lower surfaces or undercarriage. Thus, the apparatus functions as a mobile workholder and facilitates repair, restoration, and customization processes.

The preferred embodiment of the invention previously described herein comprises one pair of lifting tower assemblies, however, an alternate embodiment comprising a single lifting tower assembly may be desirable for certain applications, each lifting tower assembly having the same or similar characteristics as those defined in the description of the previous preferred embodiment.

An alternate preferred embodiment of the present invention comprises more than one pair of lifting tower assemblies, each pair having the same or similar characteristics as those previously defined, said alternate embodiment further comprising a multiplicity of torsionally stiff structural support crossmembers interconnecting said pairs of lifting tower assemblies thereby forming a complete apparatus having a stable structure.

For the purpose of clarity of explanation a vehicle to be lifted is defined as having a front, a rear, a left side corresponding to the driver side of the vehicle, a right side corresponding to the passenger side, a longitudinal axis extending in a horizontal direction between the vehicle front and the vehicle rear and located equidistant from the right and left sides of the vehicle, and a transverse axis extending in a direction perpendicular to the defined longitudinal axis when viewed in a horizontal plane.

Each pair of lifting tower assemblies is positioned such that one lifting tower assembly of each pair is located adjacent the right side of the vehicle and the second lifting tower assembly of each pair is located adjacent the left side of the vehicle and the pairs of lifting tower assemblies are spaced apart along an axis in parallel relationship to the longitudinal axis of the vehicle and at locations determined appropriate for the application to be performed.

Horizontally disposed crossmembers extending in a direction parallel to the transverse axis of the vehicle interconnect the two lifting tower assemblies of each pair in a manner such that a lower transverse crossmember is detachably attached to the base component of each of said lifting tower assemblies and an upper transverse crossmember is detachably attached to the lifting carriage assembly of each of said lifting tower assemblies. Each two pair of adjacent lifting tower assemblies are interconnected by two horizontally disposed crossmembers extending in a direction parallel to the longitudinal axis of the vehicle, each longitudinal crossmember being detachably attached to the base component of two lifting tower assemblies located on a single side of the vehicle.

The embodiment of the apparatus comprising more than one pair of lifting tower assemblies as described herein provides the ability to conveniently and easily perform restoration processes on vehicles having unusually large dimensions or excessive weight, such as limousines for example, or to lift the entire vehicle for repair, maintenance, or customization purposes.

Additionally, the apparatus disassembles completely into the separate components that have been described herewithin. The minimal size and lightweight nature of each component greatly improves the ability of the operator to quickly and easily assemble the complete apparatus and operate it without assistance, and allows the disassembled apparatus to be stored compactly when not in use or easily transported in a light duty vehicle such as a pickup truck or SUV.

### BRIEF DESCRIPTION OF THE SEVERAL VIEWS OF THE DRAWINGS

For a better understanding of the present invention and to show more clearly how it may be carried into effect, reference is made by way of example to the accompanying drawings, which show an apparatus according to the preferred embodiment of the present invention and in which:

FIG. 1 is an elevated perspective view of a preferred embodiment of a complete apparatus according to the invention.

FIG. 2 is an elevated perspective view of an individual lifting tower assembly.

FIG. 3 is a perspective view of an individual lifting tower assembly.

FIG. 4 is a side plan view of an individual lifting tower assembly.

FIG. 5 is a front plan view of an individual lifting tower assembly.

FIG. 6 is an enlarged, vertical cross-sectional view of the pulley component.

FIG. 7 illustrates a preferred embodiment of a load supporting assembly.

FIG. 8 is an end view of a pair of lifting tower assemblies interconnected by crossmembers, illustrating placement and attachment of a supported vehicle body.

FIG. 9 is a side view of a lifting tower assembly illustrating cable placement and angle.

FIG. 10 is a partial view of crossmembers attached to a base component.

FIG. 11 is an elevated perspective view of an alternate preferred embodiment of a complete apparatus according to the invention.

### DETAILED DESCRIPTION OF THE EMBODIMENTS

It is to be understood that the embodiments of the present invention disclosed herein are merely exemplary of the invention, which may be embodied in various forms. Therefore, specific structural and functional details disclosed herein are not to be interpreted as limiting.

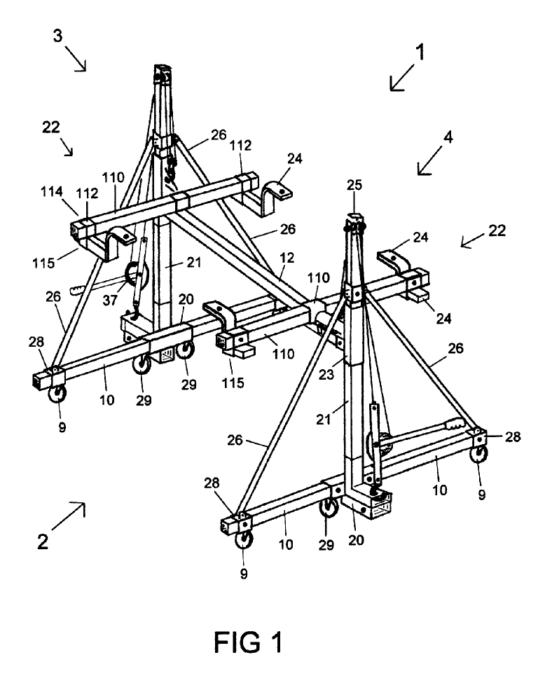

Referring now to the drawings, in which some proportions have been exaggerated for the purposes of conceptual illustration, the description of the invention is best understood by commencing with reference to FIGS. 1, 2, and 3. Attention is first directed to FIG. 1 where a complete lifting apparatus according to the invention is shown and is indicated generally as 1 and may be seen to include one pair 2 of lifting-tower assemblies 3,4. It is to be understood that the components forming one lifting tower assembly of pair 2 are the same as said components forming the second lifting tower assembly of the pair. Said lifting apparatus further includes horizontally disposed lower crossmember 13, and horizontally disposed upper crossmember 12.

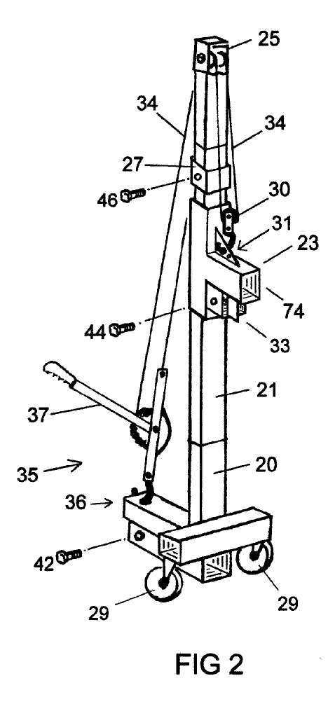

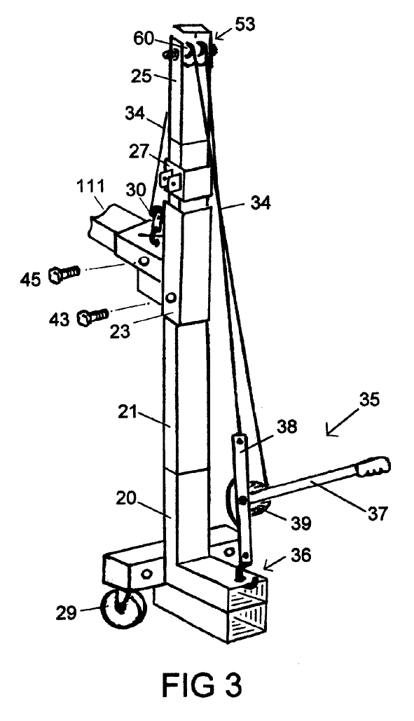

An individual lifting-tower assembly, illustrated in FIGS. 2, 3,4,5, is assembled in a desired location and includes a base 20, upright support member 21, pulley component 25, cable 34, at least one diagonal support member 26, upper collar 27, at least one lower collar 28, lifting carriage 23, load supporting assembly 22, and is provided with lifting means 35.

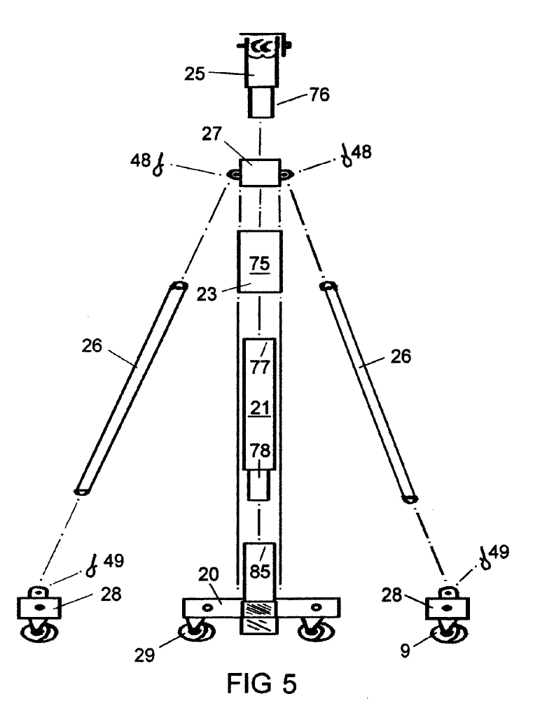

As shown in FIG. 5, base 20 includes a vertically oriented receiver portion 85. Upright support member 21 is provided with a receiver portion 77 and further includes a shank portion 78 that is vertically inserted into receiver 85.

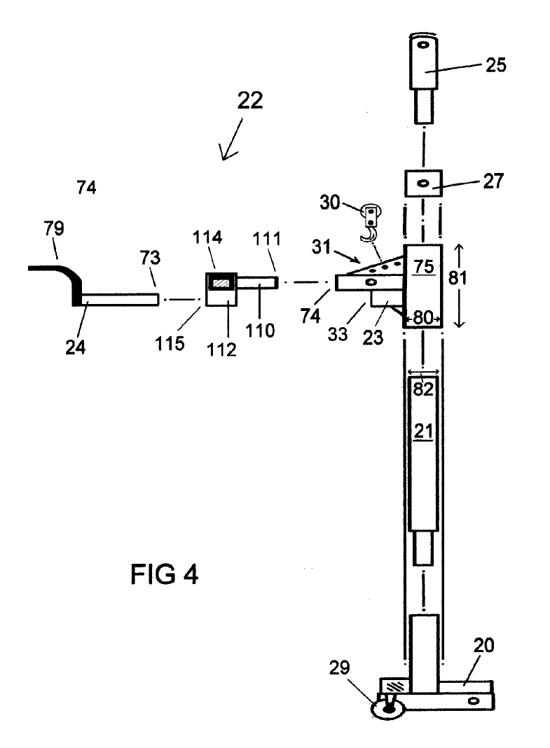

As shown in FIGS. 4,9, lifting carriage 23 includes a receiver portion 74 and is provided with a main body shaped to form a circumferential sleeve 75 having inner dimension 80 and longitudinal length 81. Upright support member 21 has longitudinal axis 32 and outer dimension 82, sleeve 75 slidably mounted thereabout. The inner dimension 80 and length 81 of sleeve 75 are proportioned relative to outer dimension 82 such that the values of inner dimension 80 and outer dimension 82 differ by no more than 0.75 percent of sleeve length 81, and preferably less than 0.35 percent, the values of inner dimension 80 and outer dimension 82 being sufficiently different as to allow unimpeded motion of lifting carriage 23 along the length of upright support member 21. Thus, an allowable range of proportional relationship is defined between sleeve length 81, inner dimension 80, and outer dimension 82, thereby further defining an allowable tolerance range existing between upright support member 21 and lifting carriage 23 when mounted theresurrounding. Lifting carriage 23 further includes mounting site 31, for attachment of a pulley device of conventional type 30.

An upper circumferential collar 27 is slidably mounted surrounding a segment of upright support member 21 and is secured at a location upwards of lifting carriage 23 by means of a threaded aperture passing through upper collar 27 and a mating bolt 46, as indicated in FIG. 2.

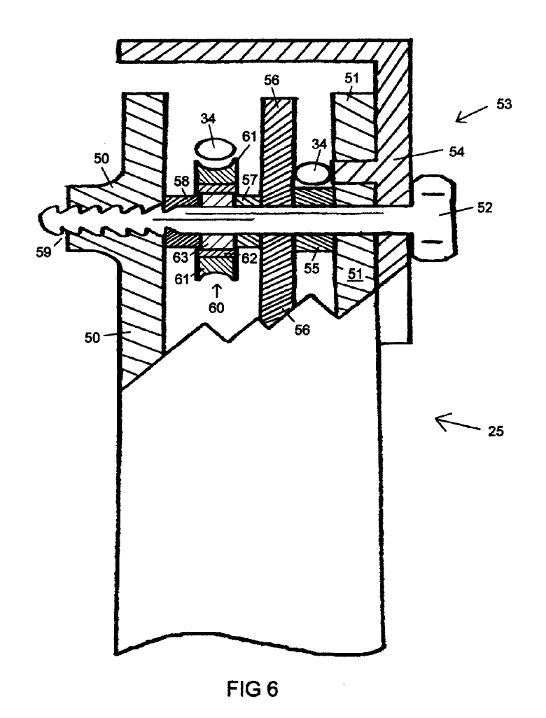

Pulley component 25 includes shank portion 76 that is slidably inserted into receiver 77 of upright support member 21, shown in FIG. 5. A cross-sectional view of pulley component 25 is illustrated in FIG. 6 and can be seen to include a conventional pulley device of the bearing type 60, comprising a cable guide 61, bearing 62, and a center 63 having bolt 52 passing therethrough, thereby securing pulley 60 between outer spacer 58 and inner spacer 57 which are located between and immediately adjacent the pulley component outer body 50 and the inside locking plate 56, respectively. A cable passing through locking device 53 is supported by cable spacer 55 and is positioned between inside locking plate 56 and the outer locking-pin plate 54. Said bolt 52 passes through the outer locking-pin plate 54, pulley component inner body 51, cable spacer 55, inside locking plate 56, inner spacer 57, pulley device 60, and outer spacer 58, each having an aperture passing therethrough. Said mating bolt 52 then passes through threaded aperture 59 in the pulley component outer body 50 thereby extending completely through said pulley component 25 in such manner that sufficient tightening of bolt 52 provides the result that cable 34 passing through locking device 53 is secured between the outer locking-pin plate 54 and inside locking plate 56 in a stationary position relative to pulley component 25, and further provides secure positioning of the pulley device 60 relative to pulley component 25.

Referring again to FIGS. 2,3, base 20 is further provided with mounting site 36 for attachment of a lifting means 35, comprising a conventional cable-pulling device of the ratcheting type hereinafter referred to as a come-along 37. Cable 34 has one tail attached to the winch portion 39 of come-along 37 and has opposite tail extending over pulley device 60 and then extending around pulley device 30 and then passing through locking device 53, said opposite tail being attached to the come-along body 38. Both tails of cable 34 are connected to come-along 37 using means recommended by the manufacturer thereof. Operation of come-along 37 is performed as per manufacturer instructions, whereby winching in or winching out cable 34 causes lifting carriage 23 to move upwards or downwards, respectively, along the vertical length of upright support member 21, said lifting carriage 23 being freely movable about upright support member 21 due to the tolerance existing therebetween as previously defined herein. Base 20 limits downward movement of lifting carriage 23 and upward movement thereof is limited to the desired height by said aforedescribed upper collar 27.

Lifting carriage 23 further includes a safety feature comprising a securing means such that said lifting carriage 23 can be secured to upright support member 21 at a desired height and in a generally immovable position, said securing means comprising a threaded aperture passing through lifting carriage 23 and a mating bolt 43, thereby preventing upward or downward movement of lifting carriage 23 regardless of whether or not a load is being supported. Hence, a vehicle or part thereof can be lifted to and maintained at a height preferred by the operator or convenient for the task to be performed.

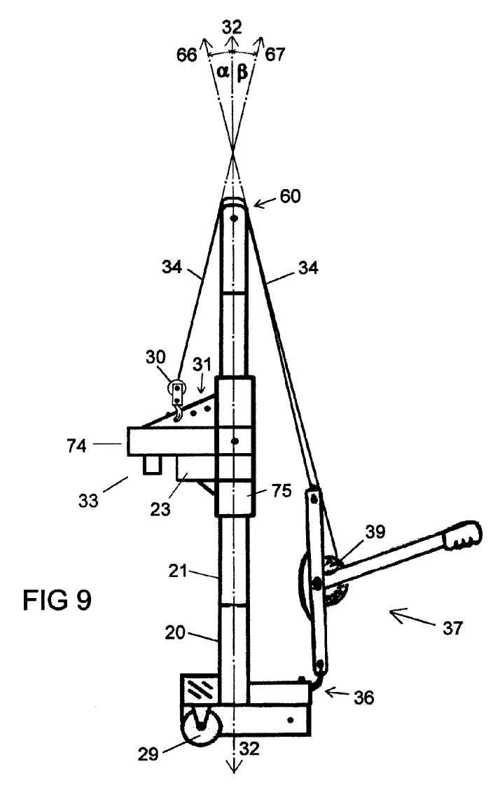

As shown in FIG. 9, base 20 is provided with mounting site 36 having location such that an axis 66 defined by the segment of cable 34 extending between pulley device 60 and ratchet 39, and the longitudinal axis 32 of upright support member 21 intersecting therewith, forms an angle alpha of not less than 4 degrees but not more than 9 degrees, and preferably between 6 degrees and 7 degrees, thereby defining an allowable range of angle alpha. Mounting site 31 has location on lifting carriage 23 such that an axis 67 defined by the segment of cable 34 extending between pulley device 30 and pulley device 60, and axis 32 intersecting therewith, forms an angle beta of not less than 2 degrees and not more than 17 degrees, and preferably between 3 degrees and 15 degrees, thereby defining an allowable range of angle beta. Mounting site 31 includes three points for attachment of pulley device 30, each of said points corresponding to a pre-determined range of allowable load weight and having location determined such that angle beta is maintained within the allowable range when pulley device 30 is attached to the attachment point which is appropriate for the weight of the load to be lifted.

Each lifting tower assembly further includes a safety feature, inherent in its design, for the purpose of preventing a catastrophic accident in the event of failure of cable 34 or come-along 37 or the lifting carriage safety feature 43, and that acts to secure lifting carriage 23 against upright support member 21 immovably in such event. Said safety feature is provided by the interrelationship between the angle of cable 34 relative to upright support member 21 (angle beta) and the aforedefined allowable tolerance range between lifting carriage sleeve 75 and upright support member 21. A failure of cable 34 or come-along 37 while the lifting tower assembly is under load results in sleeve 75 tilting or twisting relative to upright support member 21 causing a portion of the inner surface of sleeve 75 to contact and wedge against a portion of the exterior surface of upright support member 21 due to the limited tolerance existing therebetween, whereby lifting carriage 23 is prevented from continued movement along the length of upright support member 21. The previously defined tolerance range is determined such that a relatively small amount of tilting or twisting of sleeve 75 will cause lifting carriage 23 to become immobile relative to upright support member 21. The range of values allowed for angles alpha and beta, respectively, ensure sleeve 75 is maintained in an orientation relative to axis 32 such that under normal operating circumstances movement of lifting carriage 23 is unimpeded, however, events including cable failure, lifting means failure, excessive load shift, and etc., will cause lifting carriage 23 to lock against upright support member 21 before significant downward movement can occur, thereby providing a secondary safety means for preventing catastrophic accident.

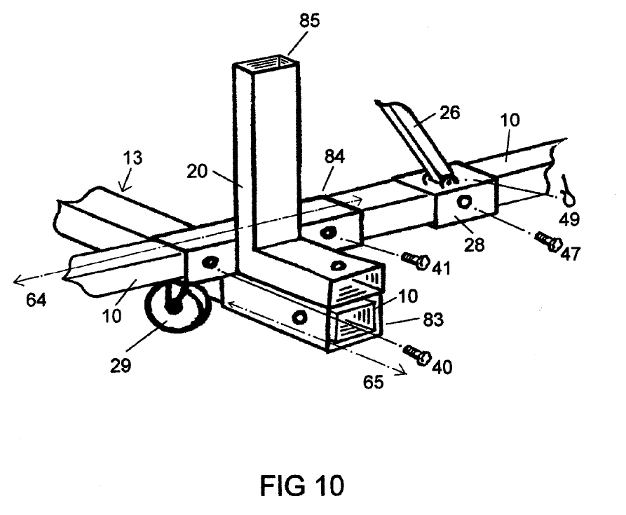

A base component 20 and attached crossmembers 10,13 are illustrated in FIG. 10. Base 20 is provided with a receiver portion 83 and a receiver portion 84 that define a transverse axis 65 and a longitudinal axis 64 respectively. As shown in FIGS. 5,10, the upright support member 21 connected to a base component 20 and the longitudinal crossmember 10 connected thereto are interconnected by at least one diagonal support member 26 having an upper end attached to said upper collar 27 and a lower end attached to a lower circumferential collar 28 slidably mounted surrounding said crossmember 10 and secured thereto by means of a threaded aperture passing through collar 28 and a mating bolt 47. Said lower collar 28 in a preferred embodiment is further provided with ground traversing means comprising wheels 9 mounted to a lower surface of said collar. Both ends of said diagonal support member 26 are secured to their respective collars by means of an aperture passing through each of said collars and each end of said diagonal support member 26 for insertion of pin 48 and 49, respectively, however an alternate method of securing each end of diagonal support member 26 to its respective collar is possible.

A load supporting assembly having sufficient strength and appropriate material composition is provided with attachment means whereby said load supporting assembly can be connected and secured to lifting carriage 23, said attachment means in a preferred embodiment comprising a shank portion shaped to allow slidable insertion within lifting carriage receiver 74 and secured thereto by means of a threaded aperture passing through lifting carriage 23 and a mating bolt, however alternate attachment means may be used to connect said load supporting assembly to lifting carriage 23 and securing means other than a threaded aperture and mating bolt are possible, such as an aperture and locking pin, for example.

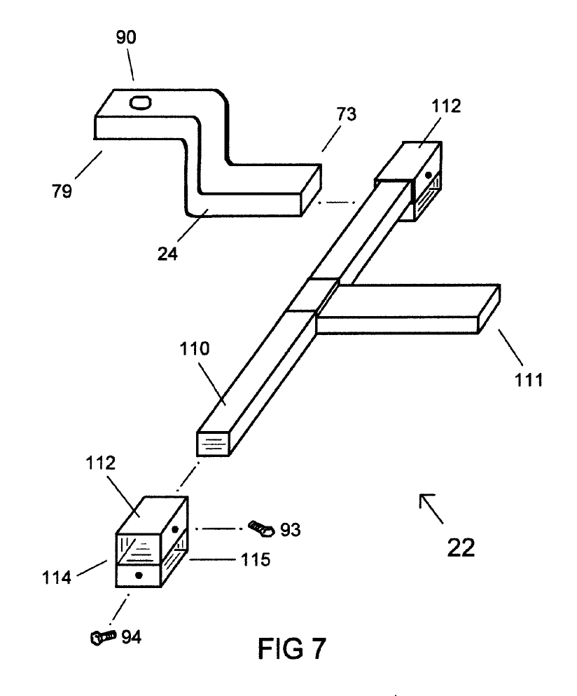

One embodiment of the aforedescribed load supporting assembly, indicated generally as 22 in FIGS. 1, 4, 7, includes a main body 110, mounting brackets 112, and load attachment arms 24. Main body 110 is provided with shank portion 111 shaped to allow slidable insertion within lifting carriage receiver 74, said shank 111 being secured thereto by means of a threaded aperture passing through lifting carriage 23 and a mating bolt 45, as noted in FIG. 3. Each mounting bracket 112 includes a portion shaped such that it forms a circumferential collar 114 having dimensions allowing said collar to be slidably mounted surrounding a positionally appropriate segment of main body 110, said collar 114 being provided with means of securing thereto, said means in a preferred embodiment comprising a threaded aperture passing through collar 114 and mating bolt 93, as illustrated in FIG. 7. Said mounting bracket 112 is further provided with a receiver portion 115 shaped to allow slidable insertion of shank 73 therewithin, said receiver 115 including means for securing shank 73 thereto, said means comprising a threaded aperture passing through receiver 115 and mating bolt 94.

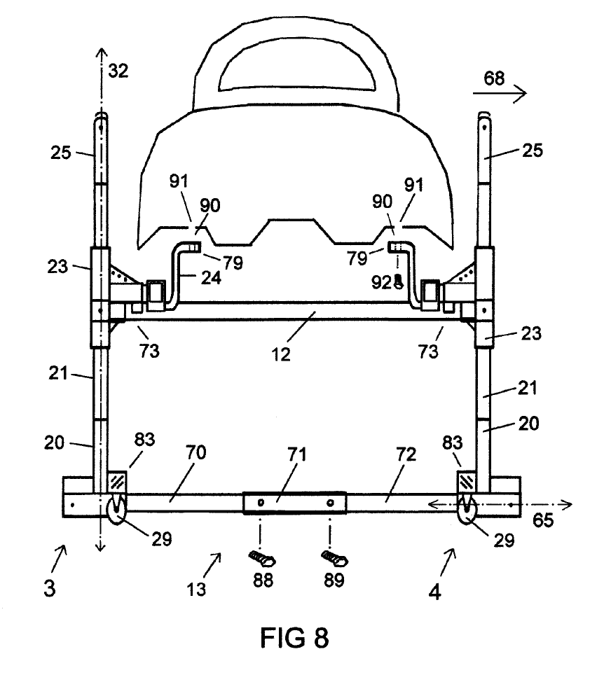

Each load attachment arm 24 is provided with a shaped portion that allows a vehicle body of the full-frame type to be attached and secured thereto in a manner whereby the vehicle body is supported from underneath by load attachment arm 24 and attached thereto at a suitably reinforced and appropriate location on the body, said shaped portion comprising a projection 79. Said projection 79 is shaped such that it can be inserted within a channel existing between the vehicle body and frame of a full-frame vehicle, and can be secured at the location of a pre-existing attachment site on the body underside commonly referred to as a body mount, said body mount including a threaded aperture 91 and mating bolt 92 whereby the vehicle body is secured to the frame, as illustrated in FIG. 8. Said body mount thereby provides a suitably reinforced and stable point for attachment of said load attachment arm 24 to the vehicle body. Projection 79 includes means for securing load attachment arm 24 to said body mount, comprising an elongated aperture 90 passing through projection 79 whereby alignment of said aperture 90 with body mount aperture 91 allows body mount mating bolt 92 to be inserted into aperture 90 and extended through projection 79 before entering the body mount threaded aperture 91, thereby securing load attachment arm 24 to the body underside when said mating bolt 92 is tightened sufficiently. Lifting carriage 23 is then raised to an elevation such that receivers 115 are at substantially the same height as each load attachment arm shank 73 and each mounting bracket 112 is positioned and secured at an appropriate location on main body 110 whereby movement of the assembled lifting tower in a direction towards said load attachment arms 24 and alignment therewith results in the slidable insertion of each shank 73 within a receiver 115. The position of the lifting tower assembly and the elevation of lifting carriage 23 may be adjusted to achieve proper insertion of shanks 73 within receivers 115, such that each shank 73 can be secured to a mounting bracket 112 by means of the aforedescribed threaded aperture mating bolt 94. Means other than a threaded aperture and mating bolt for attaching and securing said load attachment arms to said mounting brackets or said mounting brackets to said main body may be used.

An alternate load supporting assembly embodiment having the ability to support an entire vehicle from underneath the frame or undercarriage is also possible, wherein each load attachment arm includes a projecting portion having an upper surface forming a generally horizontal plane shaped to allow a vehicle frame or undercarriage to be supported thereupon in a stable manner. Additional alternate embodiments of said load-supporting assembly provided with means to engage and support loads of a type other than those mentioned herein, such as unibody vehicles for example, are also possible without departing from the underlying ideas or principals of this invention.

As shown in FIGS. 8,10, the two lifting tower assemblies 3,4, forming pair 2 are interconnected by a lower transverse crossmember 13 having ends slidably inserted within receiver 83 of each base 20, and secured thereto by means of a threaded aperture passing through receiver 83 and a mating bolt 42. A single torsionally stiff crossmember 13 is comprised of three segments 70, 71, 72, assembled and secured together by means of two threaded apertures passing through segment 71 and mating bolts 88, 89 to form a single crossmember wherein the length of said crossmember is adjustable, said crossmember 13 being shaped in such manner as to allow disassembly and removal from pair 2, and assembly and installation, while said pair 2 is supporting a load. An alternate embodiment of the present invention including a lower transverse crossmember formed as a single piece (not shown) having ends slidably inserted within and passing completely through receiver 83 of base 20 is possible, thereby providing an other method of adjusting the distance between the two lifting tower assemblies 3,4 forming pair 2.

An upper transverse crossmember 12 further interconnects pair 2, having ends slidably inserted within receiver 33 of each lifting carriage 23 and in a manner whereby upper crossmember 12 may be removed or installed between tower assembly 3 and 4 while pair 2 is supporting a load, the aforementioned outward tilt of tower assemblies 3,4 providing a means whereby said insertion and removal of crossmember 12 is possible. Said crossmember 12 is secured to lifting carriage 23 by means of a threaded aperture passing therethrough and mating bolt 44, shown in FIG. 2.

Said upper crossmember 12 further provides an additional redundant safety feature in the event of failure of both primary and secondary safety features in one tower of a pair, said previously herein described primary and backup safety features each comprising a method whereby lifting carriage 23 is secured to upright support member 21 and in a generally immovable relationship therewith. Said upper crossmember 12, being a torsionally stiff component having ends secured to lifting carriage 23 of tower assemblies 3 and 4, operatively interconnects tower assemblies 3,4, in a manner such that in the event of failure of both safety features in one tower of pair 2, tower assembly 3 for example, crossmember 12 will transfer the load to tower assembly 4 and will further result in the descending lifting carriage 23 tilting relative to upright support member 21, causing the secondary lifting carriage safety feature to become operative, thereby preventing said lifting carriage 23 from further descent. Thus, the apparatus according to the invention includes several redundant safety features.

Referring again to FIG. 9, base 20 is further provided with ground traversing means comprising wheels 29 mounted to a lower surface of base 20, said wheels 29 being positioned at locations whereby axis 32 of upright support member 21 defines a direction differing from a true vertical axis, and intersecting therewith forms an angle of not more than 3 degrees but not less than 0.5 degrees when viewed in a vertical plane having an axis in parallel relationship to axis 65 of base 20, as noted in FIG. 8. An assembled lifting tower assembly supported by base 20 having wheels 29 is thereby provided with a small but measurable tilt in an outward direction indicated by arrow 68, that is to say, the two lifting tower assemblies 3,4, forming pair 2 tilt away from each other slightly. This outward tilt provides additional stability to each pair of lifting tower assemblies, thereby reducing the possibility of a lifting tower assembly tilting or toppling toward a load being supported.

When the apparatus according to the invention is used to lift a vehicle body off its frame, the load attachment arms 24 are secured to the vehicle body and to the assembled lifting tower assemblies 3, 4, and lower horizontal crossmember 13 is attached. The vehicle body is then lifted off the frame and elevated, each lifting carriage locking means 43 is engaged, and the upper horizontal crossmember 12 is installed. Lower transverse crossmember 13 is then removed, allowing the vehicle frame, suspension, wheels, and etc., to be rolled out from beneath the body and lifting apparatus. Once the frame is removed the lower transverse crossmember is again installed, resulting in a complete lifting apparatus which is a single stable structure having a vehicle body supported thereby. Adjustment or alteration of the load elevation may be made at any point hereafter. Said apparatus, being movably supported by wheels 29, is capable of ambulatory motion over a generally level surface while supporting said load, thereby acting as a mobile workholder.

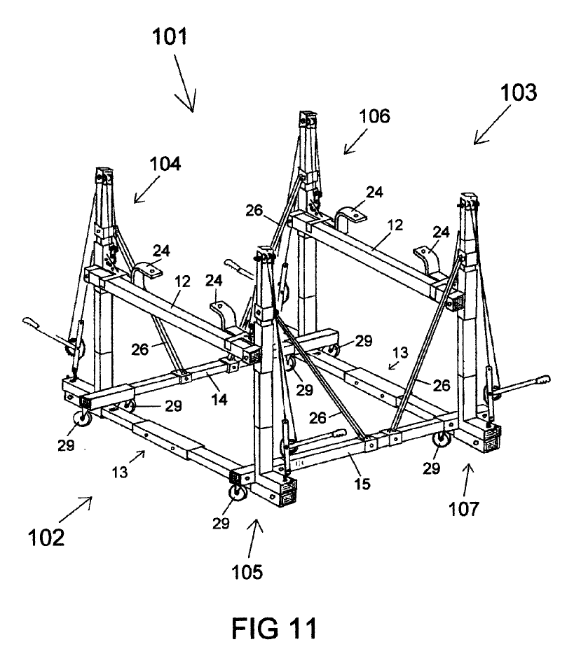

An alternate embodiment of the apparatus according to the invention is shown in FIG. 11, indicated generally as 101, and can be seen to include four lifting tower assemblies 104, 105, and 106, 107, forming two pair of lifting tower assemblies 102, 103 respectively. Said pairs 102 and 103 are interconnected by two longitudinal crossmembers 14, 15, each having ends slidably inserted within receiver 84 of base 20 and secured by means of the two threaded apertures passing through receiver 84 and mating bolts 40, 41, said receiver 84 shaped forming an aperture passing completely through base 20 whereby said longitudinal crossmember is slidably positionable within base 20 such that the distance between pairs 2 and 3 may be increased or decreased.

Alternate embodiments of said apparatus utilizing means other than a threaded aperture and mating bolt for attaching or securing crossmembers 10, 12, 13, 14, and 15 are possible without departing from the underlying ideas or principals of this invention, said means comprising an aperture and securing pin, for example.

The interconnection of assembled lifting tower assemblies 104, 105, 106, and 107 by horizontal crossmembers 12, 13, 14, and 15, and each diagonal crossmember 26 further interconnecting therewith, forms a complete apparatus which is a single stable structure capable of ambulatory motion over a generally level surface while supporting a load, said apparatus being movably supported by wheels 29.

Although a particular preferred embodiment of the apparatus according to the invention and a number of alternate embodiments have been described herein and illustrated in the figures, the principles of the present invention are not limited to those specific embodiments, and within said embodiments certain changes may be made in the form or arrangement of the parts without departing from the underlying ideas or principles of this invention.

What is claimed is:

1. A lifting and holding apparatus wherein said apparatus comprises an individual lifting tower, said lifting tower comprising:
a) base having ground traversing means;
b) upright support member comprising an elongated and torsionally stiff member extending in a generally vertical direction from said base;
c) carriage associated with said upright support member, said carriage being slidably mounted to said upright support member thus permitting movement of said carriage along the longitudinal length of said upright support member;
d) load supporting assembly having means of attachment to said carriage;
e) pulley mechanism associated with said upright support member and located upwards of said carriage and wherein said pulley mechanism includes a main body and a cable engaging pulley freely rotatably connected thereto;
f) lifting means for selectively effecting the elevation of said carriage relative to said base wherein said lifting means comprises a cable pulling device, said cable pulling device including a main body and a spool;
g) cable associated with said cable pulling device, said cable having two tails;
h) one or more crossmembers wherein each crossmember comprises an elongated and torsionally stiff member.

2. Lifting and holding apparatus in accordance with claim 1, wherein;
a) at least one of said crossmembers extends in a generally horizontal direction from said base;
b) said base is provided with means of connecting said horizontal crossmember thereto, said base further including a mounting point for attachment of said cable pulling device, said cable pulling device being attached to said mounting site;
c) said carriage includes a mounting point for attachment of a cable engaging pulley device.

3. Lifting and holding apparatus in accordance with claim 2, including:
a) one or more diagonally disposed support members oriented substantially in a vertically direction, each having an upper end and a lower end, each upper end having means of attachment to said upright support member and each lower end having means of attachment to said horizontal crossmember;
b) a cable engaging pulley device attached to said mounting point on said carriage.

4. Lifting and holding apparatus in accordance with claim 3, wherein;
a) said carriage includes a main body forming a circumferential sleeve slidably mounted surrounding a segment of said upright support member, said main body having inner dimension and longitudinal length in proportional relationship with the outer dimension of said upright support member such that the values of said inner dimension and said outer dimension differ by no more than 0.75 percent of said longitudinal length of said sleeve;
b) said carriage further includes means for securing said carriage into a fixed position relative to said upright support member;
c) said pulley mechanism further comprises a locking means disposed adjacent said pulley wherein a cable passing through said locking means is prevented from movement relative to said pulley mechanism;
d) one tail of said cable is attached to said main body of said cable pulling device and the second tail of said cable extending around said pulley of the pulley mechanism and extending around said cable engaging pulley device and passing through said locking means of the pulley mechanism is connected to said spool of said cable pulling device.

5. Lifting and holding apparatus in accordance with claim 4, wherein;
a) said mounting site on said base for said cable pulling device has location such that an axis defined by the segment of said cable extending between said main body of the cable pulling device and said pulley of the pulley mechanism and the longitudinal axis of said upright support member intersecting therewith forms an angle of at least 4 degrees and not more than 9 degrees;
b) said mounting point on said carriage for said cable engaging pulley device has location such that an axis defined by the segment of said cable extending between said cable engaging pulley device and said pulley of the pulley mechanism and the longitudinal axis of said upright support member intersecting therewith forms and angle of at least 2 degrees and not more than 17 degrees.

6. Lifting and holding apparatus in accordance with claim 5, wherein;
said locking means of said pulley mechanism comprises:
a) a pair of opposed protrusions extending from said main body to define a channel therewithin, said pair of opposed protrusions being defined as sides of said channel, and said channel being capable of receiving a cable therein;
b) a threaded aperture passing through on one of said sides and a mating bolt extending inwardly therethrough being positionable to permit contact with said cable thus permitting said bolt to be positioned to prevent movement of said cable relative to said locking means.

7. Lifting and holding apparatus in accordance with claim 5, wherein;
said locking means of said pulley mechanism comprises:
a) a threaded aperture passing through said main body to permit a mating bolt to extend inwardly therethrough, said mating bolt being positionable within said threaded aperture;
b) said main body having an first portion comprising a pair of opposed protrusions extending therefrom to define a channel therewithin, said channel extending in a direction in perpendicular relationship to said threaded aperture and disposed adjacent said threaded aperture, and said channel being capable of receiving a cable therein;
c) an aperture passing through one of said pair of opposed protrusions of said first portion wherein said pair of opposed protrusions are defined as sides of said channel;
d) said main body having an second portion disposed adjacent said first portion, said second portion having a protrusion extending inwardly through said aperture in said first portion to permit contact with said cable, and wherein said mating bolt is positively rotatably engaged within said threaded aperture to cause said cable to be locked into a fixed position relative to said pulley mechanism and wherein said bolt is negatively rotatably engaged within said threaded aperture to cause said cable to be released from a fixed position relative to said pulley mechanism.

8. Lifting and holding apparatus in accordance with claim 1, wherein;
each of said (a) through (h) is an individually separate component and wherein;
i) said upright support member is detachably connected to said base;
ii) said carriage is detachably mounted to said upright support member;
iii) said load supporting assembly is detachably attached to said carriage;
iv) said pulley mechanism is detachably connected to said upright support member;
v) said cable pulling device is detachably attached to said base.

9. Lifting and holding apparatus in accordance with claim 8 and method of assembly wherein;
each of said individual components are brought into cooperation to form a lifting and holding apparatus, and wherein the method includes:
a) the step of connecting said upright support member to said base;
b) the step of mounting said carriage to said upright support member;
c) the step of attaching said load supporting assembly to said carriage;
d) the step of connecting said pulley mechanism to said upright support member;
e) the step of attaching said cable pulling device to said base;
f) the step of connecting one of said tails of said cable to said spool of the cable pulling device and attaching the second tail of said cable to said main body of said cable pulling device.

10. A lifting and holding apparatus and method of assembly wherein said apparatus comprises one or more pair of individual lifting towers and wherein two or more crossmembers interconnect the two lifting towers of each pair, each of said lifting towers comprising:
a) base having ground traversing means;
b) upright support member comprising an elongated and torsionally stiff member extending in a generally vertical direction from said base;
c) carriage associated with said upright support member, said carriage being slidably mounted to said upright support member thus permitting movement of said carriage along the longitudinal length of said upright support member, said carriage further including a mounting point for attachment of a cable engaging pulley device;
d) load supporting assembly having means of attachment to said carriage;
e) pulley mechanism associated with said upright support member and located upwards of said carriage and wherein said pulley mechanism includes a main body and a cable engaging pulley freely rotatably connected thereto;
f) lifting means for selectively effecting the elevation of said carriage relative to said base wherein said lifting means comprises a cable pulling device, said cable pulling device including a main body and a spool;
g) cable associated with said cable pulling device, said cable having two tails;
h) one or more crossmembers wherein each crossmember comprises an elongated and torsionally stiff member extending in a generally horizontal direction from said base.

11. Lifting and holding apparatus in accordance with claim 10, wherein;
a) at least one torsionally stiff member disposed in a generally horizontal direction interconnects said base of the first lifting tower of each pair with said base of the second lifting tower of each pair, said lower horizontal crossmember being detachably connected to each base;
b) a torsionally stiff member interconnects said carriage of the first lifting tower of each pair with said carriage of the second lifting tower of each pair, said upper horizontal crossmember being detachably connected to each carriage.

12. Lifting and holding apparatus in accordance with claim 11, wherein;
a) said load supporting assembly includes at least one body attachment arm having means of attachment to said load supporting assembly, said arm being provided with a protrusion shaped to allow insertion within a channel existing between a vehicle body and the frame of said vehicle, said vehicle body having a pre-existing attachment site adjacent said channel, said attachment site comprising a threaded aperture and mating bolt;
b) said arm is further provided with means for securing to said attachment site, said means comprising an elongated aperture passing through said projection to permit said mating bolt to extend inwardly therethrough whereby said mating bolt extending inwardly through said elongated aperture and extending inwardly through said threaded aperture secures said arm to said vehicle body when said mating bolt is positively engaged within said threaded aperture.

13. Lifting apparatus in accordance with claim 11, including:
a) one or more diagonally disposed support members oriented substantially in a vertically direction, each having an upper end and a lower end, each upper end having means of attachment to said upright support member and each lower end having means of attachment to said horizontal crossmember;
b) a cable engaging pulley device attached to said mounting point on said carriage.

14. Lifting apparatus in accordance with claim 13, wherein;
a) said carriage includes a main body forming a circumferential sleeve slidably mounted surrounding a segment of said upright support member, said main body having inner dimension and longitudinal length in proportional relationship with the outer dimension of said upright support member such that the values of said inner dimension and said outer dimension differ by no more than 0.75 percent of said longitudinal length of said sleeve;
b) said carriage further includes means for securing said carriage into a fixed position relative to said upright support member;
c) said pulley mechanism further comprises a locking means disposed adjacent said pulley wherein said cable passing through said locking means is prevented from movement relative to said pulley mechanism;
d) said base is provided with means of connecting said horizontal crossmember thereto, said base further including a mounting point for attachment of said cable pulling device, said cable pulling device being attached to said mounting point;
e) one tail of said cable is attached to said main body of said cable pulling device and the second tail of said cable extending around said pulley of the pulley mechanism and extending around said cable engaging pulley device and passing through said locking means of the pulley mechanism is connected to said spool of said cable pulling device.

15. Lifting and holding apparatus in accordance with claim 14, wherein;
a) said mounting site on said base for said cable pulling device has location such that an axis defined by the segment of said cable extending between said main body of the cable pulling device and said pulley of the pulley mechanism and the longitudinal axis of said upright support member intersecting therewith forms an angle of at least 4 degrees and not more than 9 degrees;
b) said mounting point on said carriage for said cable engaging pulley device has location such that an axis defined by the segment of said cable extending between said cable engaging pulley device and said pulley of the pulley mechanism and the longitudinal axis of said upright support member intersecting therewith forms and angle of at least 2 degrees and not more than 17 degrees;
c) said means for securing said carriage into a fixed position relative to said upright support member comprises a threaded aperture passing through said carriage for receiving a mating bolt, and wherein said mating bolt is positively engaged within said threaded aperture to cause said bolt to lock said carriage into a fixed position relative to said upright support member and wherein said bolt is negatively engaged to cause said bolt to release said carriage.

16. Lifting and holding apparatus in accordance with claim 15, wherein;
said base resides on two or more wheels, said wheels having location such that an axis defined by the longitudinal direction of said upright support member connected to said base differs from a true vertical axis and intersecting therewith forms an angle of not more than 3 degrees and not less than 0.5 degrees.

17. Lifting and holding apparatus in accordance with claim 14, wherein;
said locking means of said pulley mechanism comprises:
a) a threaded aperture passing through said main body to permit a mating bolt to extend inwardly therethrough, said mating bolt being positionable within said threaded aperture;
b) said main body having an first portion comprising a pair of opposed protrusions extending therefrom to define a channel therewithin, said channel extending in a direction in perpendicular relationship to said threaded aperture and disposed adjacent said threaded aperture, and said channel being capable of receiving a cable therein;
c) an aperture passing through one of said pair of opposed protrusions of said first portion wherein said pair of opposed protrusions are defined as sides of said channel;
d) said main body having an second portion disposed adjacent said first portion, said second portion having a protrusion extending inwardly through said aperture in said first portion to permit contact with said cable, and wherein said mating bolt is positively rotatably engaged within said threaded aperture to cause said cable to be locked into a fixed position relative to said pulley mechanism and wherein said bolt is negatively rotatably engaged within said threaded aperture to cause said cable to be released from a fixed position relative to said pulley mechanism.

18. Lifting and holding apparatus in accordance with claim 10, wherein;
each of said (a) through (h) is an individually separate component and wherein;
i) said upright support member is detachably connected to said base;
ii) said carriage is detachably mounted to said upright support member;
iii) said load supporting assembly is detachably attached to said carriage;
iv) said pulley mechanism is detachably connected to said upright support member;
v) said cable pulling device is detachably attached to said base.

19. Lifting and holding apparatus in accordance with claim 11 and method of assembly wherein;
each of said individual components are brought into cooperation to form a lifting and holding apparatus, and wherein the method includes:
a) the step of connecting said upright support member to said base;
b) the step of mounting said carriage to said upright support member;
c) the step of attaching said load supporting assembly to said carriage;
d) the step of connecting said pulley mechanism to said upright support member;
e) the step of attaching said cable pulling device to said base;
f) the step of connecting one of said tails of said cable to said spool of the cable pulling device and attaching the second tail of said cable to said main body of said cable pulling device;
g) the step of positioning each lifting tower assembly adjacent the load to be lifted;
h) the step of connecting said lower horizontal crossmember to the base of both lifting towers that form a pair.

20. Lifting and holding apparatus in accordance with claim 12 and method of assembly wherein the method includes:
a) the step of positioning each lifting tower assembly adjacent the vehicle body to be lifted;
b) the step of attaching each load attachment arm to an attachment site on said vehicle body;
c) the step of attaching each load attachment arm to a load supporting assembly;
d) the step of connecting said lower horizontal crossmember to the base of both lifting towers that form a pair;
e) the step of separating said vehicle body from its frame and elevating said vehicle body;
f) the step of connecting said upper horizontal crossmember to the carriage of both lifting towers that form a pair;
g) the step of disconnecting said lower horizontal crossmember from the base of both lifting towers that form a pair;
h) the step of removing said vehicle frame from beneath the elevated vehicle body;
i) the step of reconnecting said lower horizontal crossmember to the base of both lifting towers that form a pair.
